(19) United States
(12) Patent Application Publication
(10) Pub. No.: US 2016/0212968 A1
(43) Pub. Date: Jul. 28, 2016

(54) CONICAL ANIMAL DISH

(71) Applicant: Steven Ritnour, Bremerton, WA (US)

(72) Inventor: Steven Ritnour, Bremerton, WA (US)

(21) Appl. No.: 14/604,487

(22) Filed: Jan. 23, 2015

(51) Int. Cl. A01K 5/01; A01K 5/02

(52) U.S. Cl. CPC A01K 5/0114; A01K 5/0225

(57) ABSTRACT

An animal dish. The animal dish includes a base for supporting the animal dish. The animal dish also includes a food container. The food container is configured to hold the food for consumption and includes a conical inner surface.

### CROSS-REFERENCE TO RELATED APPLICATIONS

Not applicable.

### BACKGROUND OF THE INVENTION

Traditional animal dishes with rounded containers suffer from a number of drawbacks. For example, rounded food containers can cause whisker stress. Animal whiskers are highly sensitive. Therefore, as the whiskers brush the side of the dish, this can cause stress to the animal. This is often manifest by the animal either tipping the dish or by taking large bites of food and placing them on the floor before actual consumption occurs.

In addition, rounded food containers cause food to spoil. In particular, the large surface area of food exposed to air causes the food to dry out. This makes the food less appealing to the animal and causes to spoliation.

Accordingly, there is a need in the art for a animal dish that reduces whisker stress. In addition, there is a need in the art for an animal dish that will reduce the surface area of food exposed to air.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes an animal dish. The animal dish includes a base for supporting the animal dish. The animal dish also includes a food container. The food container is configured to hold the food for consumption and includes a conical inner surface.

Another example embodiment includes an animal dish. The animal dish includes a base. The animal dish also includes a hopper. The hopper is configured to hold food for an animal and includes an outlet hole on its lower portion. The animal dish further includes a food container. The food container is configured to receive the food from the hopper and is configured to hold the food for consumption. The food container includes a conical inner surface.

Another example embodiment includes an animal dish. The animal dish includes a base. The animal dish also includes a hopper. The hopper is configured to hold food for an animal and includes an outlet hole on its lower portion. The animal dish further includes a food container. The food container is configured to receive the food from the hopper and is configured to hold the food for consumption. The food container includes a conical inner surface. The animal dish additionally includes animal food within the hopper and the food container.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates a perspective view of an example of an animal dish containing food;

FIG. 1B illustrates a cut-away side view of an example of an animal dish containing food; and

FIG. 2 illustrates an example of an automatic animal feeder.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

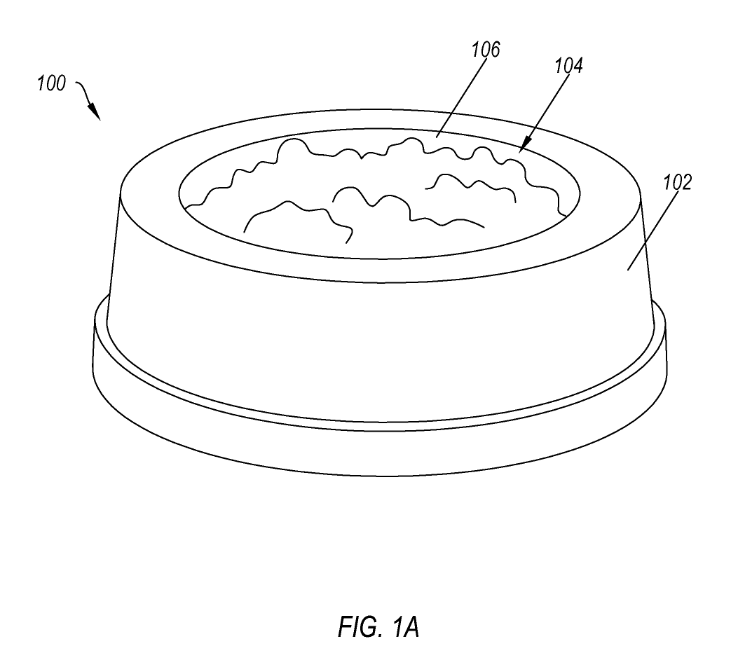

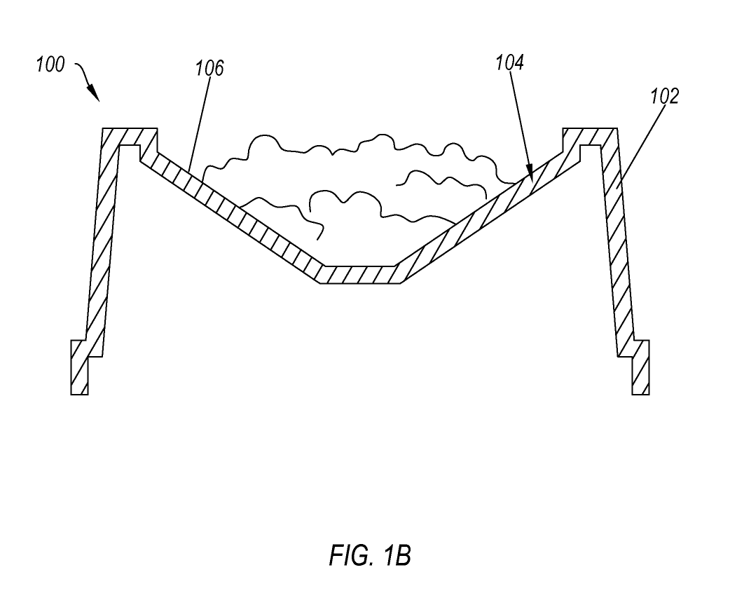

FIGS. 1A and 1B (collectively “FIG. 1”) illustrate an example of an animal dish 100. FIG. 1A illustrates a perspective view of an example of an animal dish 100 containing food; and FIG. 1B illustrates a cut-away side view of an example of an animal dish 100 containing food. The animal dish 100 is configured to hold food or liquid for an animal's consumption. The animal may include a domesticated animal, such as a pet, or a wild animal. For example, an animal owner may place food in the animal dish 100 for consumption by an animal. The animal dish 100 can include a simple dish or an automatic animal feeder, where food or water is dispensed as the food or liquid is consumed by the animal. As used in the specification and the claims, the phrase “configured to” denotes an actual state of configuration that fundamentally ties recited elements to the physical characteristics of the recited structure. As a result, the phrase “configured to” reaches well beyond merely describing functional language or intended use since the phrase actively recites an actual state of configuration.

FIG. 1 shows that the animal dish 100 includes a base 102. The base 102 is configured to support the animal dish 100. I.e., the base 102 rests on a floor or other surface where the animal dish 100 is accessible to the animal. The base 100 can include any desired material, such as metal, plastic, wood or stone.

FIG. 1 also shows that the animal dish 100 includes a food container 104. The food container 104 can be permanently attached to the base or may be removable. For example, the food container 104 can be an insert which can be removed from the base. An insert allows the food container 104 to be removed as desired. For example, the base can include a food and water insert, allowing a user to remove the desired insert for cleaning or feeding/watering or to make only food or water available at a particular time. Additionally or alternatively, the food container 104 as an insert can allow the base 102 to include a moat or other device for preventing insects from entering the food container 104.

FIG. 1 further shows that the food container 104 can include a conical inner surface 106. The conical inner surface 106includes the portion of the food container 104 which is in contact with the food or liquid. The conical inner surface 106 can be critical for eliminating whisker stress. Whiskers provide an animal with sensory information about its surroundings. For example, a cats whiskers allow the cat to determine what size opening they can fit through because they are the same size as a cat's body. Whiskers also help an animal navigate in low light without bumping into anything, detect the slightest disturbance by measuring air currents, and help the animal determine the best way to navigate around an object. When the animal attempts to eat from a curved bowl, the animal's whiskers press against the sides of the bowl, making it difficult for the cat to sense anything but plastic or ceramic.

Additionally, the conical inner surface 106 can be critical for allowing gravity keeps food in the center of the dish. In a dish with a flat surface, the food can spread out. The conical inner surface 106, in contrast, forces all food into the middle of the food container 104. That is, food automatically centers within the food container 104. Thus, the conical inner surface 106 can create a lower surface area of food exposed to the air. Food exposed to the air loses moisture and/or begins to spoil. Therefore, a conical inner surface 106 can help soft food retain its moisture longer.

The angle of the cone and the size of the opening (i.e., base of the cone) can vary depending on the animal which is to be fed. I.e., smaller animals can have a smaller opening and/or smaller angle. For example, the diameter of the opening can be between 3 inches and 12 inches and the angle of the cone vary from between 35 degrees to 70 degrees.

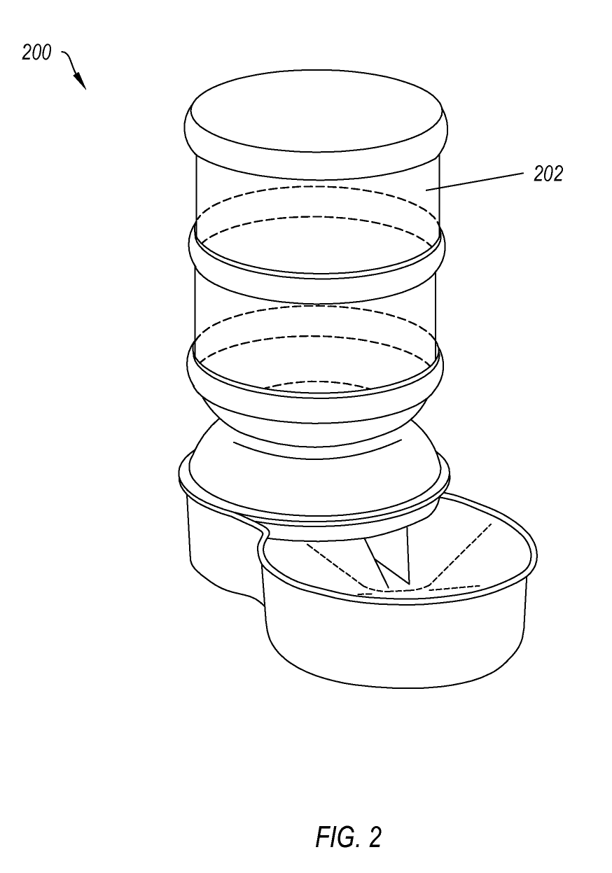

FIG. 2 illustrates an example of an automatic animal feeder 200. The automatic animal feeder 200 includes a hopper 202. The hopper 202 contains additional food. The additional food falls into the food container, allowing the automatic animal feeder 200 to contain a larger amount of food for the animal. The hopper 202 can be transparent, allowing a user to visually inspect the food/water and to determine the amount of food present.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An animal dish, the animal dish comprising:
a base for supporting the animal dish;
a food container, the food container:
is configured to hold animal food for consumption; and
includes a conical inner surface.

2. The animal dish of claim 1, wherein the opening of the conical inner surface is between 3 inches and 12 inches.

3. The animal dish of claim 1, wherein the angle of the conical inner surface is between 35 degrees and 70 degrees.

4. The animal dish of claim 1, wherein the base includes a moat.

5. The animal dish of claim 1, wherein the base includes metal.

6. The animal dish of claim 1, wherein the base includes plastic.

7. The animal dish of claim 1, wherein the base includes wood.

8. The animal dish of claim 1, wherein the base includes stone.

9. An animal dish, the animal dish comprising:
a base;
a hopper, wherein the hopper:
is configured to hold food for an animal; and
includes an outlet hole on its lower portion; and
a food container, the food container:
is configured to receive the food from the hopper
is configured to hold the food for consumption; and
including a conical inner surface.

10. The animal dish of claim 9, wherein the opening of the conical inner surface is between 3 inches and 12 inches.

11. The animal dish of claim 9, wherein the angle of the conical inner surface is between 35 degrees and 70 degrees.

12. The animal dish of claim 9, wherein the base includes a moat.

13. The animal dish of claim 9, wherein the base includes metal.

14. The animal dish of claim 9, wherein the base includes plastic.

15. The animal dish of claim 9, wherein the base includes wood.

16. The animal dish of claim 9, wherein the base includes stone.

17. The animal dish of claim 9, wherein the hopper is transparent.

18. An animal dish, the animal dish comprising:
a base;
a hopper, wherein the hopper:
is configured to hold food for an animal; and
includes an outlet hole on its lower portion; and
a food container, the food container:
is configured to receive the food from the hopper
is configured to hold the food for consumption; and
including a conical inner surface; and
animal food within the hopper and the food container.
